(19) United States
(12) Patent Application Publication
(10) Pub. No.: US 2016/0372814 A1
(43) Pub. Date: Dec. 22, 2016

(54) ANTENNA APPARATUS

(71) Applicant: SONY CORPORATION, Tokyo (JP)

(72) Inventors: Tomomichi Murakami, Tokyo (JP); Yoshitaka Yoshino, 1-7-1 Konan, Minato-ku (JP); Satoru Tsuboi, Kanagawa (JP)

(73) Assignee: Sony Corporation, Tokyo (JP)

(21) Appl. No.: 14/898,940

(22) PCT Filed: May 1, 2014
(86) PCT No.: PCT/JP2014/002384

§ 371 Date: Dec. 16, 2015

(30) Foreign Application Priority Data
Jul. 2, 2013 (JP) 2013-139111

(51) Int. Cl. H01Q 1/08; H01Q 7/08; H01Q 1/32; H01Q 9/30; H01Q 1/48

(52) U.S. Cl. CPC H01Q 1/084; H01Q 9/30; H01Q 1/48; H01Q 1/3291; H01Q 7/08

(57) ABSTRACT

[Object]

[Solving Means] An antenna apparatus includes: a first antenna element and a second antenna element that receive at least one of broadcast waves and signals transmitted while being superimposed on the broadcast waves; and a ground element that functions as a common ground of the first antenna element and the second antenna element, at least one of the first antenna element and the second antenna element having an adjustable attachment angle.

### TECHNICAL FIELD

The present disclosure relates to an antenna apparatus applicable to an in-vehicle antenna, for example.

### BACKGROUND ART

As antennas of car navigation apparatuses equipped in vehicles and PNDs (Personal Navigation Devices) mounted on vehicles, there is proposed a film antenna attachable to a front glass or a rear glass (see, for example, Patent Document 1 below).

Patent Document 1: Japanese Patent Application Laid-open No. Hei 11-017595

### SUMMARY OF INVENTION

### Problems to be Solved by the Invention

However, to neatly attach the film antenna at an appropriate position on a window of a vehicle is difficult for general users. In addition, since a material having a sufficient electrical conductivity is not used for the film antenna and an antenna cable is long, there has been a problem that a gain is smaller than that of a rod antenna. As a result, there has been a problem that a use of an amplifier is necessary.

Therefore, an object of the present disclosure is to provide an antenna apparatus capable of performing a diversity reception and solving the problems described above.

### Means for Solving the Problems

For solving the problems described above, according to the present disclosure, there is provided an antenna apparatus including:

a first antenna element and a second antenna element that receive at least one of broadcast waves and signals transmitted while being superimposed on the broadcast waves; and

a ground element that functions as a common ground of the first antenna element and the second antenna element,

at least one of the first antenna element and the second antenna element having an adjustable attachment angle.

### Effect of the Invention

By the first antenna element and the second antenna element, it becomes possible to perform a diversity reception. Further, according to at least one embodiment, an antenna apparatus that can be easily attached and has excellent reception performance is provided. Furthermore, by providing the ground element, the ground element and the metal portion are capacitively coupled when the antenna apparatus is used as an in-vehicle antenna. As a result, an area of the portion that functions as the ground is enlarged, and reception characteristics of the antenna can therefore be improved. It should be noted that the effects described herein are not necessarily limited, and any effect described in the present disclosure may be attained. Moreover, the contents of the present disclosure should not be interpreted limitedly by the exemplified effects.

### BRIEF DESCRIPTION OF DRAWINGS

FIG. 1 A diagram for explaining an example of a structure of an antenna apparatus according to an embodiment.

FIG. 2 A diagram for explaining an example of a structure of an antenna apparatus according to the embodiment.

FIG. 3A is a diagram for explaining an example of a structure of a rod antenna element according to the embodiment, and FIG. 3B is a diagram for explaining an example of a protrusion formed on the rod antenna element.

FIGS. 4A and 4B are diagrams for explaining a jack into which a plug of the rod antenna element according to the embodiment is to be inserted.

FIG. 5 A diagram for explaining an example of a structure of a coaxial cable according to the embodiment.

FIG. 6 A diagram for explaining another example of the structure of the coaxial cable according to the embodiment.

FIG. 7 A diagram for explaining another example of the structure of the coaxial cable according to the embodiment.

FIG. 8A is a diagram showing a C/N ratio of signals received by a wire antenna element according to the embodiment, and FIG. 8B is a diagram showing a C/N ratio of signals received by the rod antenna element according to the embodiment.

FIG. 9 A diagram for explaining an arrangement example of the antenna apparatus according to the embodiment.

FIG. 10 A diagram for explaining an arrangement example of the antenna apparatus according to the embodiment.

FIG. 11A is a graph showing an example of frequency-gain characteristics of the wire antenna element in a UHF band according to the embodiment, and FIG. 11B is tables showing an example of gain characteristics at a time the wire antenna element receives a vertical polarization and a horizontal polarization.

FIG. 12A is a graph showing an example of the frequency-gain characteristics of the rod antenna element in the UHF band according to the embodiment, and FIG. 12B is tables showing an example of gain characteristics at a time the rod antenna element receives the vertical polarization and the horizontal polarization.

FIG. 13 A graph showing an example of a directivity of the wire antenna element according to the embodiment.

FIG. 14 Tables showing measurement data obtained when the directivity of the wire antenna element is measured as an example according to the embodiment.

FIG. 15 A graph showing an example of a directivity of the rod antenna element according to the embodiment.

FIG. 16 Tables showing measurement data obtained when the directivity of the rod antenna element is measured as an example according to the embodiment.

FIG. 17 A diagram schematically showing the vertical polarization and the horizontal polarization.

FIG. 18 A diagram showing an example of correlation coefficients of the wire antenna element and the rod antenna element.

FIG. 19 A diagram for explaining a modified example.

FIG. 20 A diagram for explaining a modified example.

### MODES FOR CARRYING OUT THE INVENTION

Hereinafter, an embodiment etc. of the present disclosure will be described with reference to the drawings. It should be noted that the descriptions will be given in the following order.

### 1. Embodiment

### 2. Modified Example

The embodiment etc. described below are preferable specific examples of the present disclosure, and contents of the present disclosure should not be limited to the embodiment etc.

### 1. Embodiment

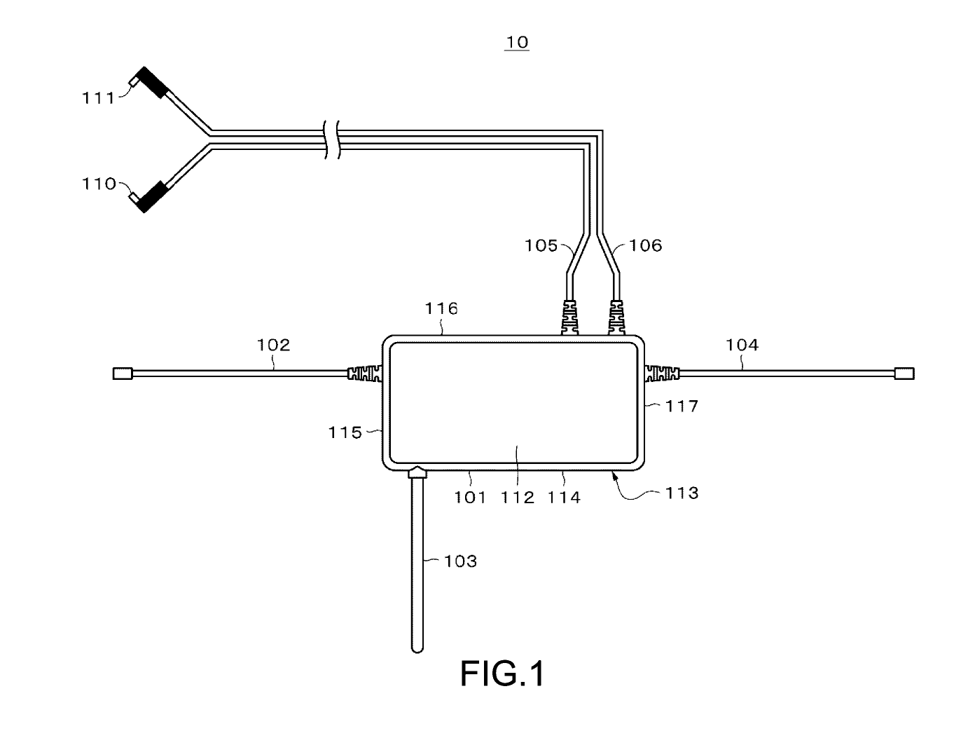

The embodiment of the present disclosure will be described. FIG. 1 shows an example of a structure of an antenna apparatus 10 according to the embodiment. The antenna apparatus 10 according to the embodiment is provided inside a vehicle, for example. The antenna apparatus 10 receives at least one of broadcast waves and signals transmitted while being superimposed on the broadcast waves. The broadcast waves are those of digital terrestrial broadcast that uses a frequency of a UHF band, and the signals transmitted while being superimposed on the broadcast waves are those of data broadcast, for example.

The antenna apparatus 10 includes, for example, a case 101 obtained by molding a synthetic resin, an antenna element 102, an antenna element 103, a ground element 104, and two coaxial cables (coaxial cable 105 and coaxial cable 106).

The antenna element 102 as an example of a first antenna element is structured as a wire antenna element that uses a coaxial cable, for example. The antenna element 103 as an example of a second antenna element is structured as a stick-type rod antenna element. Those are of course mere examples, and both antenna elements may be constituted of either the wire antenna element or the rod antenna element. It should be noted that in the descriptions below, the antenna element 102 and the antenna element 103 will respectively be referred to as wire antenna element 102 and rod antenna element 103 as appropriate.

Accommodated inside the case 101 is a wiring substrate as an example of a power feed section. As the material of the case 101, a heat-resistant ABS resin is used, for example. The case 101 includes a main surface 112, a back surface 113 on the other side of the main surface, and four side surfaces (side surface 114, side surface 115, side surface 116, and side surface 117).

Connected to the case 101 are the wire antenna element 102, the rod antenna element 103, the ground element 104, the coaxial cable 105, and the coaxial cable 106. For example, the wire antenna element 102 is connected to the side surface 115, and the rod antenna element 103 is connected to the side surface 114. For example, the ground element 104 is connected to the side surface 117, and the coaxial cable 105 and the coaxial cable 106 are connected to the side surface 116.

The rod antenna element 103 is detachable from the case 101. The wire antenna element 102 may also be structured to be detachable from the case 101.

The wire antenna element 102 and the rod antenna element 103 constitute the antenna. By setting the total length obtained by adding the length of the wire antenna element 102 and the length of the rod antenna element 103 to be about λ/2 the frequency to be received, the antenna apparatus 10 can receive a desired frequency. The length of the wire antenna element 102 according to the embodiment is set to be, for example, 12 cm (centimeters), and the length of the rod antenna element 103 is set to be, for example, 10 cm.

The ground element 104 is constituted of a coaxial cable, for example. The length of the ground element 104 is set to be, for example, 11 cm. The wire antenna element 102 and the ground element 104 described above are connected to the substrate accommodated inside the case 101 by solder or the like. The ground element 104 is bent in a predetermined direction and set in the vicinity of a metal portion of a car body, for example.

At a tip end of the coaxial cable 105, a round plug is attached. For example, an audio plug 110 of φ3.5 mm (millimeters) is attached. Similarly, at a tip end of the coaxial cable 106, a 3-prong audio plug 111 of φ3.5 mm, for example, is attached. The audio plug 110 and the audio plug 111 are connected to a PND (not shown), for example.

It should be noted that the coaxial cable 105 and the coaxial cable 106 may be structured as a so-called glasses-type cable in which the cables are formed integrally. Further, as a countermeasure for noises, the coaxial cable 105 and the coaxial cable 106 may be inserted into a ferrite core. The number of times the cables are wound (number of turns) in this case can be set as appropriate.

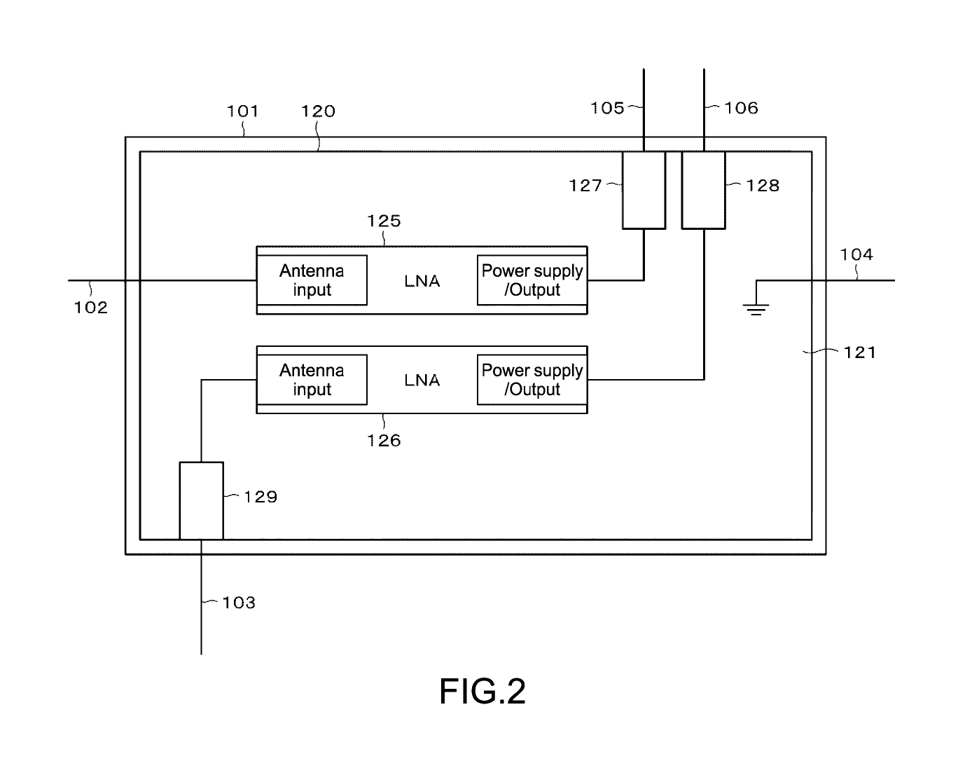

FIG. 2 shows an example of the structure of the case 101. It should be noted that in FIG. 2, illustrations of the antenna elements and the like are partially simplified. A wiring substrate 120 is accommodated inside the case 101. On a surface of the wiring substrate 120, a ground conductor (earth conductor) 121 is formed directly or via an insulating film. The ground conductor 121 is also formed on the back surface of the wiring substrate 120 and is usually connected to the ground conductor 121 on the front surface via a through hole or the like to thus function as a ground. The ground element 104 is connected to the ground conductor 121 so that the ground element 104 functions as a common ground of the wire antenna element 102 and the rod antenna element 103.

Connection sections 127, 128, and 129 are formed on the wiring substrate 120. The connection section 127 is constituted of, for example, the plug formed at the tip end of the coaxial cable 105 and the jack into which the plug is inserted. The connection section 128 is constituted of, for example, the plug formed at the tip end of the coaxial cable 106 and the jack into which the plug is inserted. A dipole plug is formed at the tip end of each of the coaxial cable 105 and the coaxial cable 106, for example. The jack into which the plug is inserted has a structure corresponding to the plug, that is, a 3-prong jack in this example.

The connection section 129 is constituted of, for example, the plug formed at the tip end of the rod antenna element 103 and the jack into which the plug is inserted. A 3-prong plug is formed at the tip end of the rod antenna element 103, for example. The jack into which the plug is inserted has a structure corresponding to the plug, that is, a 3-prong jack in this example.

LNAs (Low Noise Amplifiers) 125 and 126 are formed on the wiring substrate 120. The LNAs 125 and 126 are used for improving an S/N ratio (Signal to Noise Ratio) of a reception signal before a demodulation and are each structured by combining circuit devices such as a resistor, a coil, and a transistor as appropriate.

The wire antenna element 102 is connected to an input section (antenna input) of the LNA 125. An output section (power supply/output) of the LNA 125 and the connection section 127 are connected so that power for operating the LNA 125 is supplied from the PND as a connection destination of the coaxial cable 105 to the LNA 125. Further, an antenna signal that is received by the wire antenna element 102 and amplified by the LNA 125 is supplied to the PND via the coaxial cable 105. The antenna signal is superimposed on a power supply voltage.

The connection section 129 is connected to an input section (antenna input) of the LNA 126. An output section (power supply/output) of the LNA 126 and the connection section 129 are connected so that power for operating the LNA 126 is supplied from the PND as a connection destination of the coaxial cable 106 to the LNA 126. Further, an antenna signal that is received by the rod antenna element 103 and amplified by the LNA 126 is supplied to the PND via the coaxial cable 106. The antenna signal is superimposed on a power supply voltage.

[Example of Structure of Rod Antenna Element]

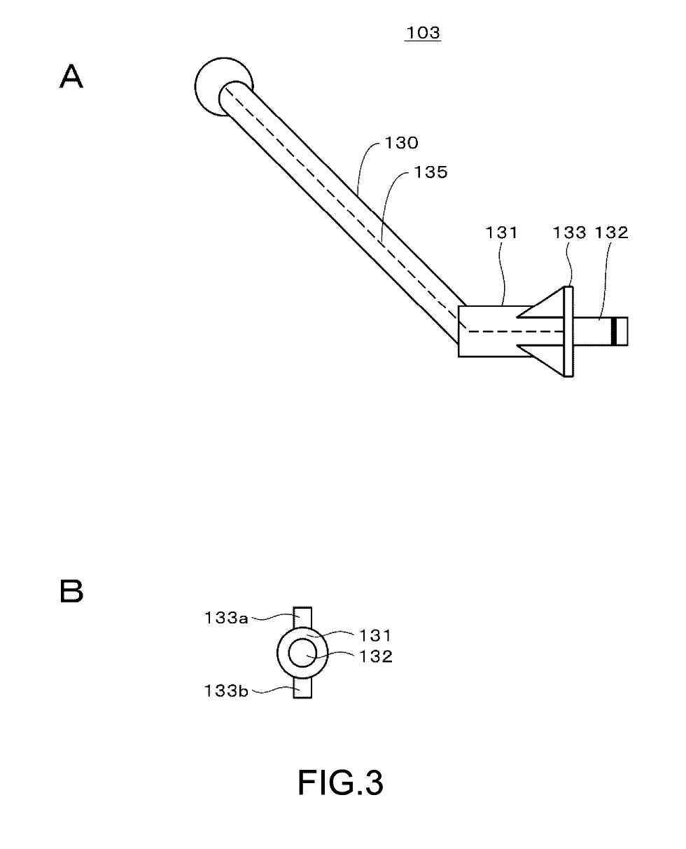

An example of the structure of the rod antenna element 103 will be described. FIG. 3A is a side view of the rod antenna element 103. The rod antenna element 103 includes, for example, an antenna section 130 and a support section 131 that supports the antenna section 130. The support section 131 is cylindrical, for example, and one end surface side thereof is connected to the antenna section 130. The antenna section 130 is attached while being bent a predetermined angle (e.g., about 45 to 60 degrees) with respect to the support section 131, for example.

A wire rod 135 constituted of a polyurethane wire (UEW wire) or a coaxial wire is inserted into the antenna section 130 and the support section 131. The antenna section 130 and the support section 131 are formed by molding the circumference of the wire rod 135 by a resin, for example. As the resin, a heat-resistant PVC (Poly Vinyl Chloride) material, a heat-resistant PP (Poly Propylene) material, or the like is used.

On the other one of the end surfaces (other end surface), a plug 132 constituted of an audio plug of φ3.5 mm is attached, for example. As shown in FIG. 3B, a flanged protrusion 133 is formed in the vicinity of the other end surface of the support section 131. The protrusion 133 is constituted of a protrusion 133a and a protrusion 133b, for example.

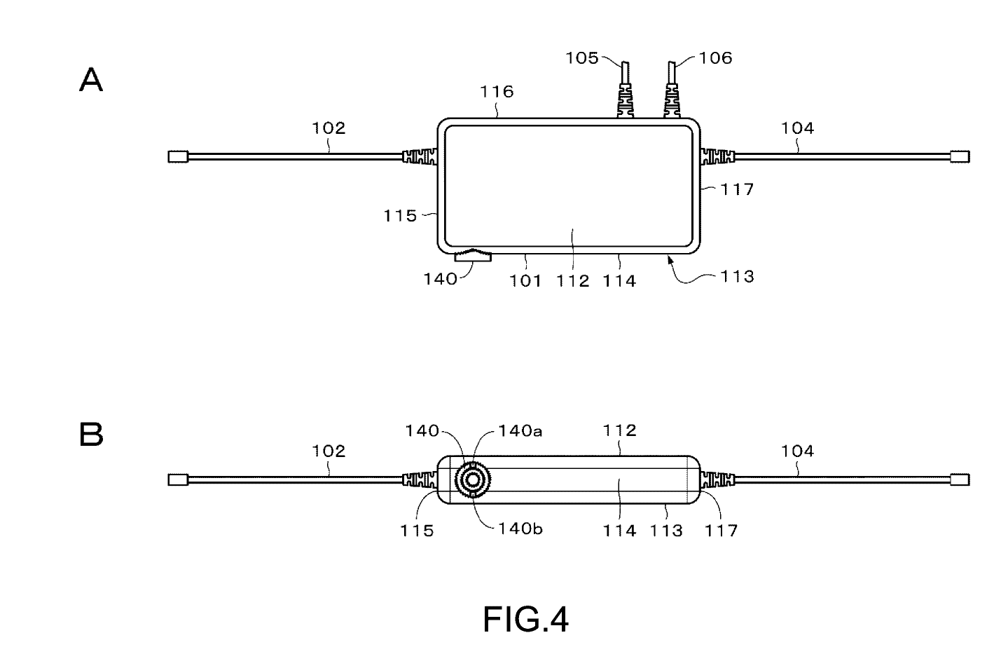

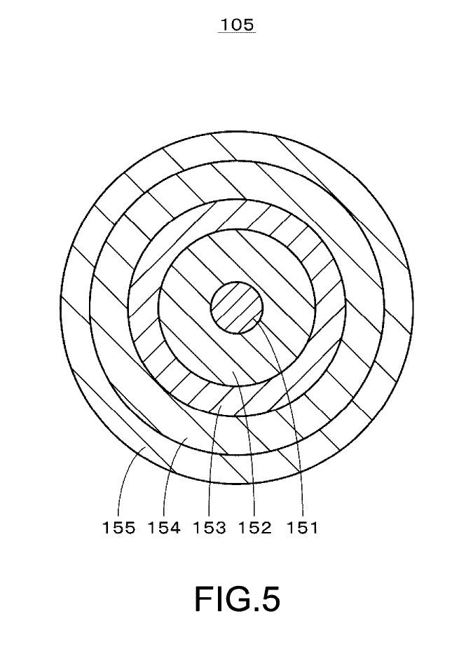

As shown in FIGS. 4A and 4B, on the side surface 114 of the case 101, a jack 140 for attaching the rod antenna element 103 is formed. FIG. 4B shows an example of the structure of the jack 140. The jack 140 includes a positioning groove 141 constituted of a groove section 141a and a groove section 141b.

By inserting the protrusion 133 into the positioning groove 141, the rod antenna element 103 can be attached to the case 101 in a predetermined positional relationship. The attachment angle of the rod antenna element 103 can be adjusted based on the insertion position of the protrusion 133 with respect to the positioning groove 141. For example, the attachment angle of the rod antenna element 103 can be differentiated between a case where the protrusion 133a is inserted into the groove section 141a and the protrusion 133b is inserted into the groove section 141b and a case where the protrusion 133a is inserted into the groove section 141b and the protrusion 133b is inserted into the groove section 141a.

It should be noted that it is also possible to connect the antenna section 130 and the support section 131 via a rotary mechanism so that the antenna section 130 can rotate while forming an angle of substantially 180 degrees from the end surface of the support section 131. The attachment angle of the rod antenna element 103 may be made adjustable by causing the antenna section 130 to rotate.

It should be noted that in this embodiment, the rod antenna element 103 including the bent antenna section 130 is detachable from the case 101. The size of the entire antenna apparatus 10 can be made small by detaching the rod antenna element 103 from the case 101, and thus the antenna apparatus 10 can be packed easily in a predetermined box and the like.

### Example of Structure of Coaxial Cable

An example of the structure of the coaxial cable 105 according to the embodiment will be described. It should be noted that the structure of the coaxial cable 106 is the same.

FIG. 5 shows an example of a cross section of the coaxial cable 105. An insulator 152 formed of polyethylene and the like covers an outside of an annealed copper wire 151 as an example of an inner conductor, and braided wires 153 are formed on an outer side thereof. On the outer side of the braided wires 153, a ferrite material layer (referred to as ferrite material as appropriate) 154 for mainly preventing noises from the PND is formed. An outer coat 155 covers an outside of the ferrite material 154.

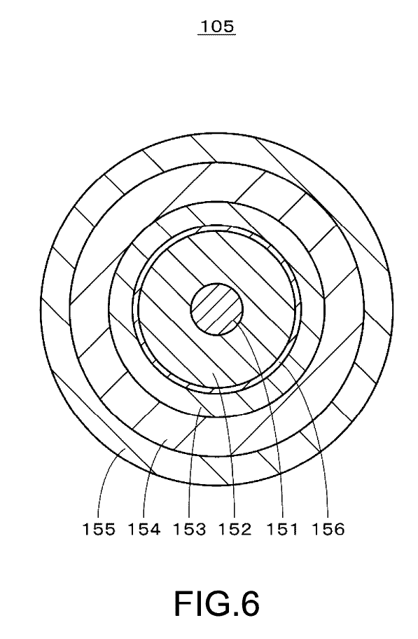

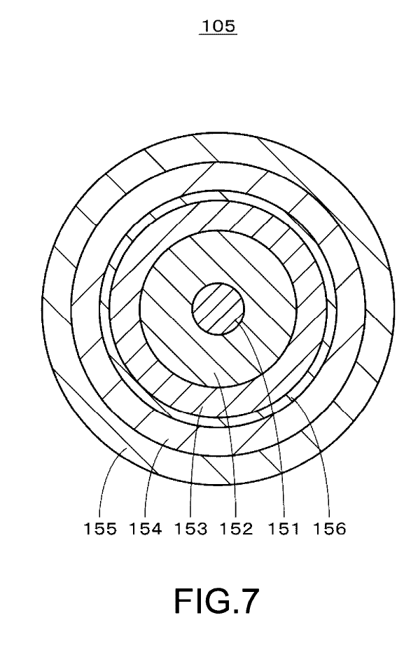

FIGS. 6 and 7 each show another example of the cross section of the coaxial cable 105. A shield material may be provided for enhancing a shield property with respect to noises. For example, as shown in FIG. 6, a single-sided aluminum foil tape 156 may be provided between the insulator 152 and the braided wires 153. The single-sided aluminum foil tape 156 is attached such that an inner surface (surface on insulator 152 side) is an insulating tape and an outer surface (surface on braided wires 153 side) is aluminum. As shown in FIG. 7, the single-sided aluminum foil tape 156 may also be provided between the braided wires 153 and the ferrite material 154. The shield material is not limited to an aluminum foil and may be a copper foil.

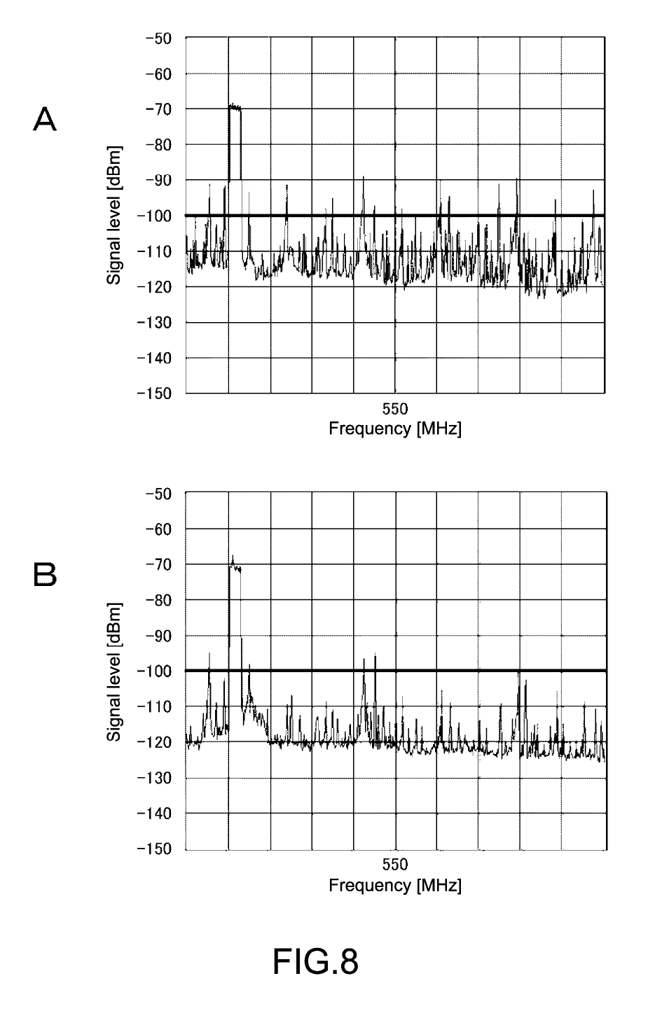

FIG. 8A is a graph showing a C/N (Carrier to Noise) ratio of reception signals in a case where an ordinary coaxial cable is used, and FIG. 8B is a graph showing a C/N ratio of reception signals in a case where a coaxial cable including a ferrite material is used. In FIGS. 8A and 8B, the abscissa axis represents a frequency (MHz), and the ordinate axis represents a signal level (dBm).

The C/N ratio is expressed by a gap between the signal level and the noise floor level in the graph. Here, while the signal levels are both around −70 dBm, the noise floor level of FIG. 8B is lower than that of FIG. 8A. Specifically, the coaxial cable that uses the ferrite material has a larger C/N ratio and more favorable reception signal quality than the normal coaxial cable. This is considered to be because the ferrite in the coaxial cable suppresses degradation of the C/N ratio due to the output cable receiving noises radiated from the PND. From the descriptions above, it is favorable to use a ferrite material for the coaxial cable.

[Example of Arrangement of Antenna Apparatus]

Two antenna apparatuses 10 are used to perform 4 diversity receptions, for example. 4 diversity receptions are used when receiving broadcast that uses a high-order modulation system, such as full segment broadcast.

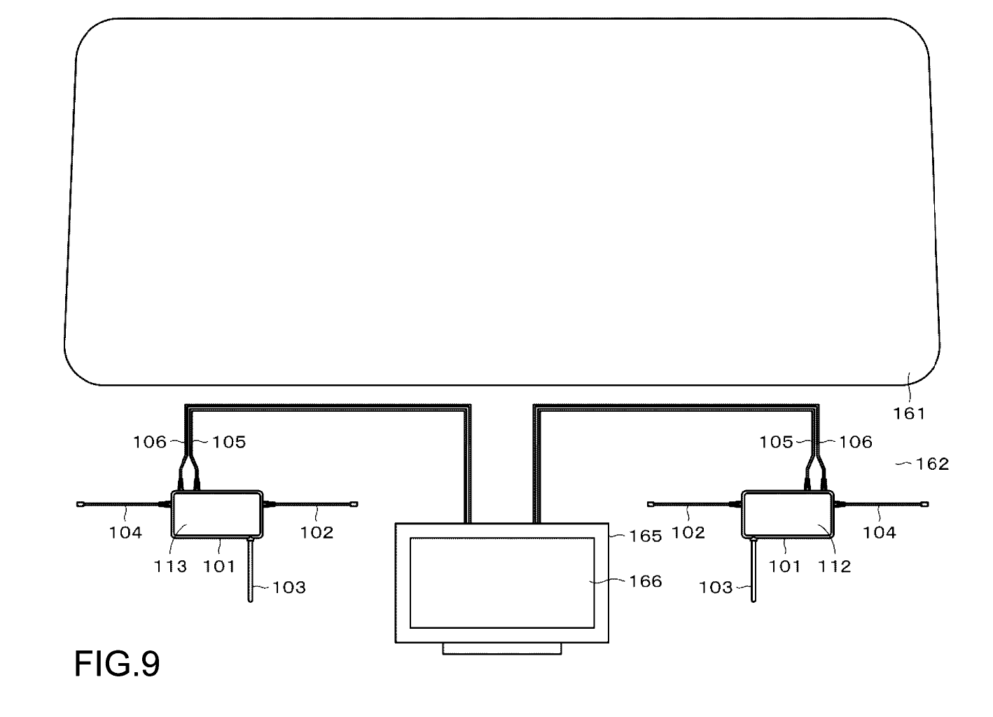

FIG. 9 is a diagram showing an attachment example of the antenna apparatus 10 to a vehicle. The example shown in FIG. 9 shows a case where two antenna apparatuses 10 are set at substantially symmetrical positions (right end and left end) of a dashboard 162 that is in contact with a lower side of a front glass 161 of the vehicle. The antenna apparatus 10 at the right end is set on the dashboard 162 while its main surface 112 faces upward. The antenna apparatus 10 at the left end is set on the dashboard 162 while its back surface 113 faces upward. As described above, each of the antenna apparatuses 10 can be used as both the left and right antenna apparatuses 10 by merely inverting the main surface 112 of the case 101.

The wire antenna element 102 is attached to the dashboard 162 so as to be substantially parallel to the lower side of the front glass 161. The wire antenna element 102 is attached to the dashboard 162 using a clamper, an adhesive, a tape, and the like. In a state where the wire antenna element 102 is set on the dashboard 162, the rod antenna element 103 is positioned in a height direction with respect to the dashboard 162.

The ground element 104 is attached along the right or left side of the front glass 161. Metal bodies (hereinafter, referred to as pillars as appropriate) that connect a vehicle and a vehicle ceiling are provided at the left and right sides of the front glass 161.

The tip end of the coaxial cable 105 (audio plug 110) and the tip end of the coaxial cable 106 (audio plug 111) are connected to a PND 165. A receiver (not shown) is incorporated into the PND 165, and the receiver performs the diversity reception, demodulation, and the like. According to the embodiment, a maximum ratio combining system of a spatial diversity is used as an example of the diversity reception. The signals demodulated by the receiver are supplied to a display 166 and the like to be reproduced as a video and audio.

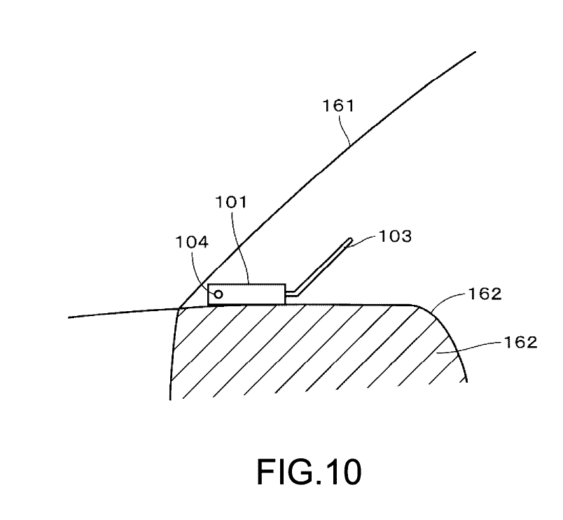

FIG. 10 is a left side view of the antenna apparatus 10 set at the left end of the dashboard 162. The case 101 of the antenna apparatus 10 is attached to the dashboard 162. It should be noted that the case 101 is attached to the dashboard 162 using an adhesive tape, a sucker, or the like.

As described above, the antenna section 130 of the rod antenna element 103 is attached so as to form substantially 45 degrees, for example, instead of a right angle from the support section 131. Therefore, the antenna apparatus 10 can be set on a rear side of the dashboard 162 without causing the rod antenna element 103 to come into contact with the front glass 161. It should be noted that for facilitating the setting of the antenna apparatus 10 to the dashboard 162, a mark may be placed on the front surface of the case 101. For example, arrows indicating the same direction may be placed on the main surface 112 and back surface 113 of the case 101. The user only needs to set the antenna apparatus 10 so that the direction of the arrows matches a traveling direction of the vehicle.

By providing the ground element 104 on or in the vicinity of the pillar, the ground element 104 and the pillar are capacitively coupled to thus enlarge the antenna ground. Accordingly, the level of reception signals to be received by the antenna apparatus 10 is raised, and in addition, reception characteristics during traveling are also improved.

Further, since the number of antennas can be easily increased, the diversity reception can be performed with ease. As exemplified in FIG. 9, by inverting the case of one of the two antenna apparatuses 10 and appropriately inserting the rod antenna elements, 4 diversity receptions by 4 antenna elements can be performed. Since there is no need to differently structure the antenna apparatuses set on the left- and right-hand sides, a die for producing the antenna apparatuses can be used in common, and costs in mass-producing antenna apparatuses can be reduced.

Furthermore, since 4 diversity receptions can be performed, it becomes possible to receive full segment broadcast and display high-definition letters and videos on the display. In addition, since there is no need to attach an antenna outside the vehicle, it becomes possible to prevent an outer appearance of the vehicle from becoming poor.

[Example of Gain Characteristics of Antenna]

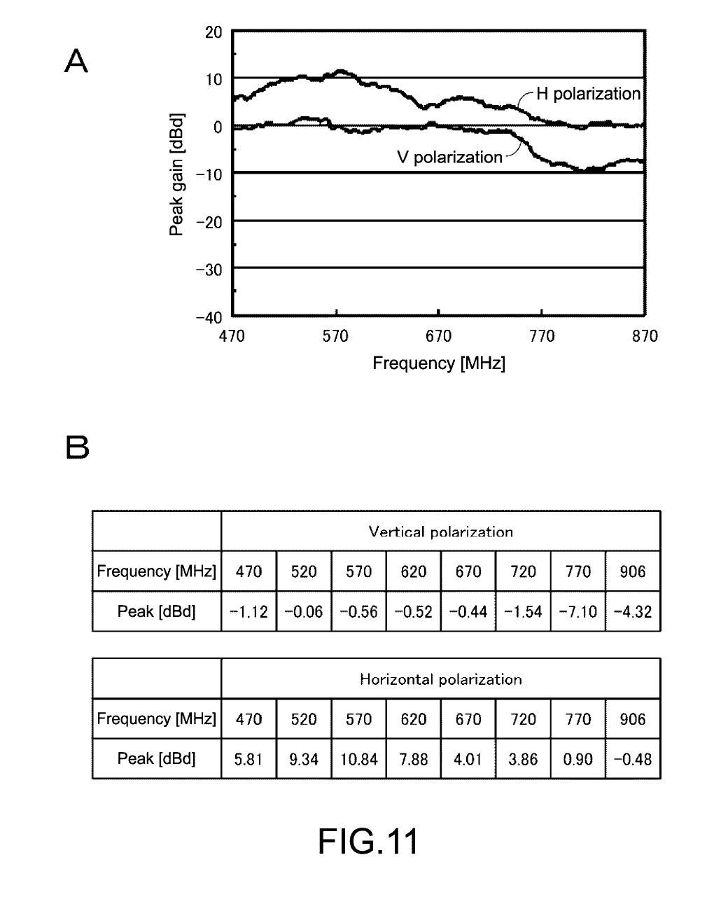

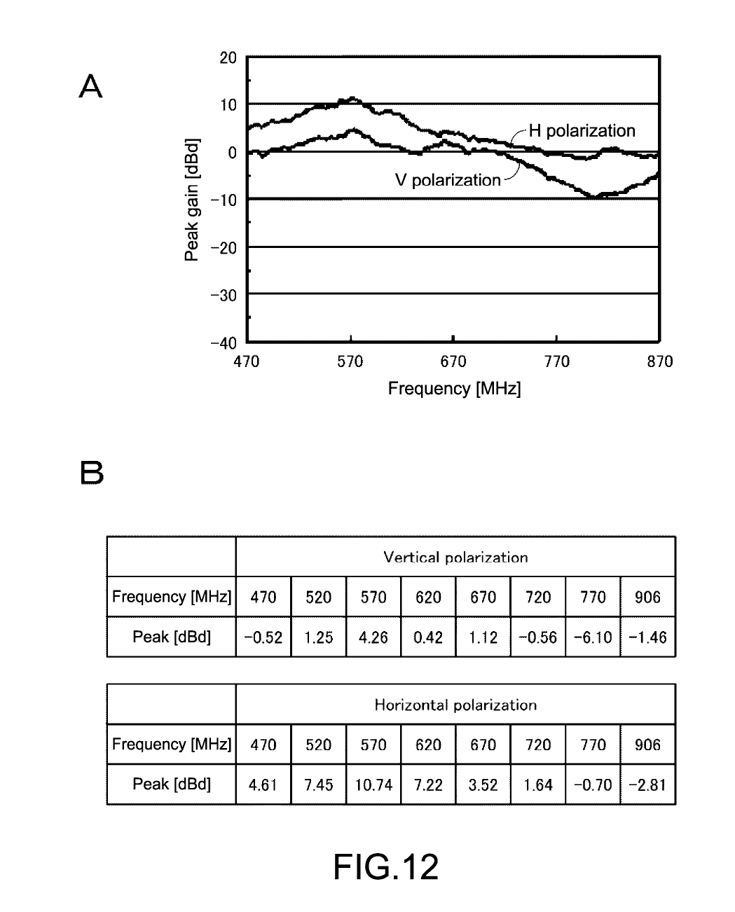

FIG. 11 show an example of antenna gain characteristics of a port 1, and FIG. 12 show an example of the antenna gain characteristics of a port 2. The port 1 is a level of UHF-band broadcast signals received by the wire antenna element 102 and amplified by the LNA 125, and the port 2 is a level of UHF-band broadcast signals received by the rod antenna element 103 and amplified by the LNA 126. It should be noted that the coaxial cable 105 and the coaxial cable 106 having the length of 1.5 m are used.

FIGS. 11A and 12A are graphs, and FIGS. 11B and 12B show data. The abscissa axis in each of FIGS. 11A and 12A represents a frequency (MHz), and the ordinate axis represents a peak gain (dBd). In the graphs, the line indicated as “H polarization” indicates frequency-gain characteristics in a horizontal polarization reception, and the line indicated as “V polarization” indicates the frequency-gain characteristics in a vertical polarization reception.

As can be seen from FIGS. 11 and 12, by applying the LNAs, it was confirmed that the gain characteristics of 0 dB or more can generally be obtained in the horizontal polarization as a main polarization of the UHF-band television broadcast.

[Example of Antenna Directivity and Correlation Coefficient]

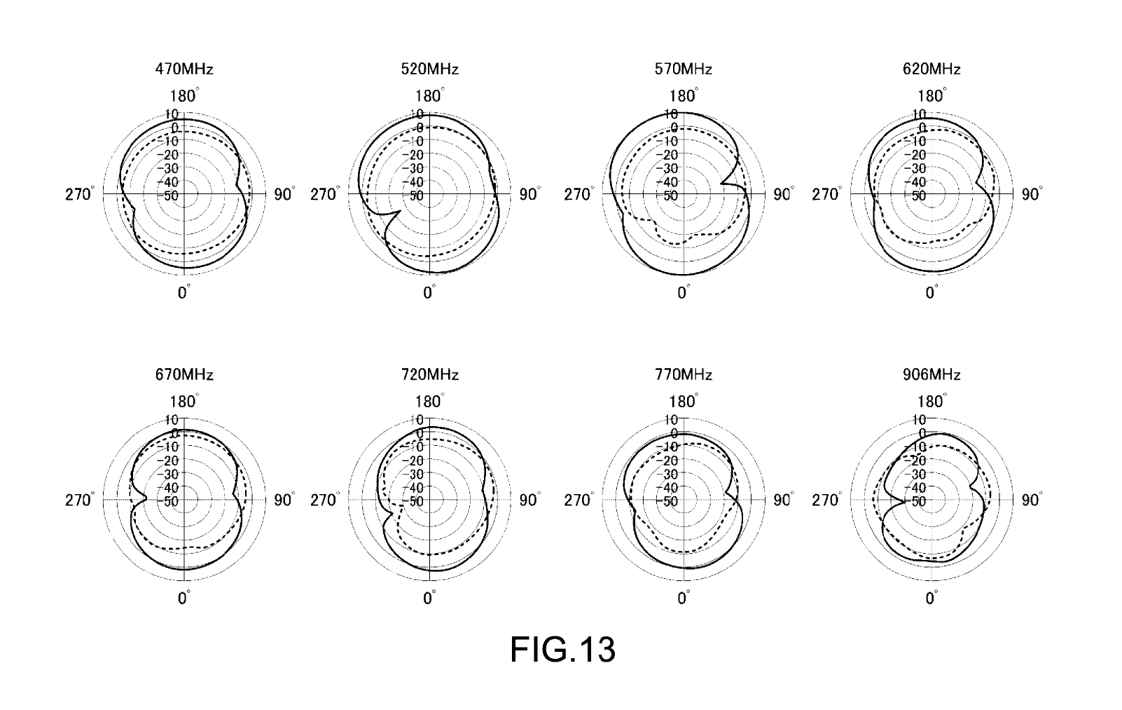

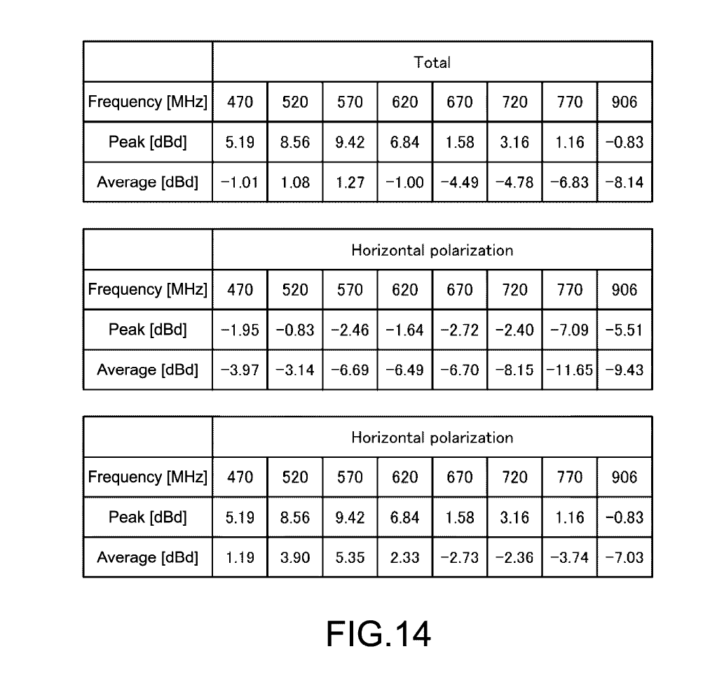

FIG. 13 shows measurement graphs regarding a directivity of the wire antenna element 102. FIG. 14 shows measurement data regarding the directivity of the wire antenna element 102. FIG. 14 shows measurement data in the horizontal polarization reception, measurement data in the vertical polarization reception, and total measurement data.

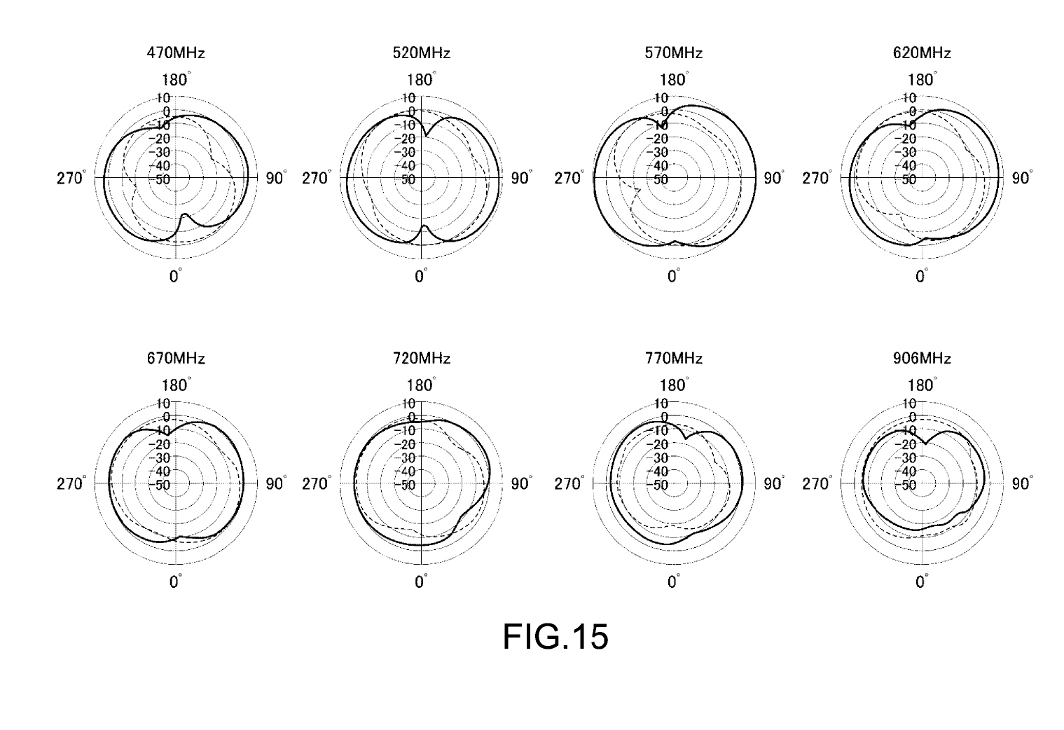

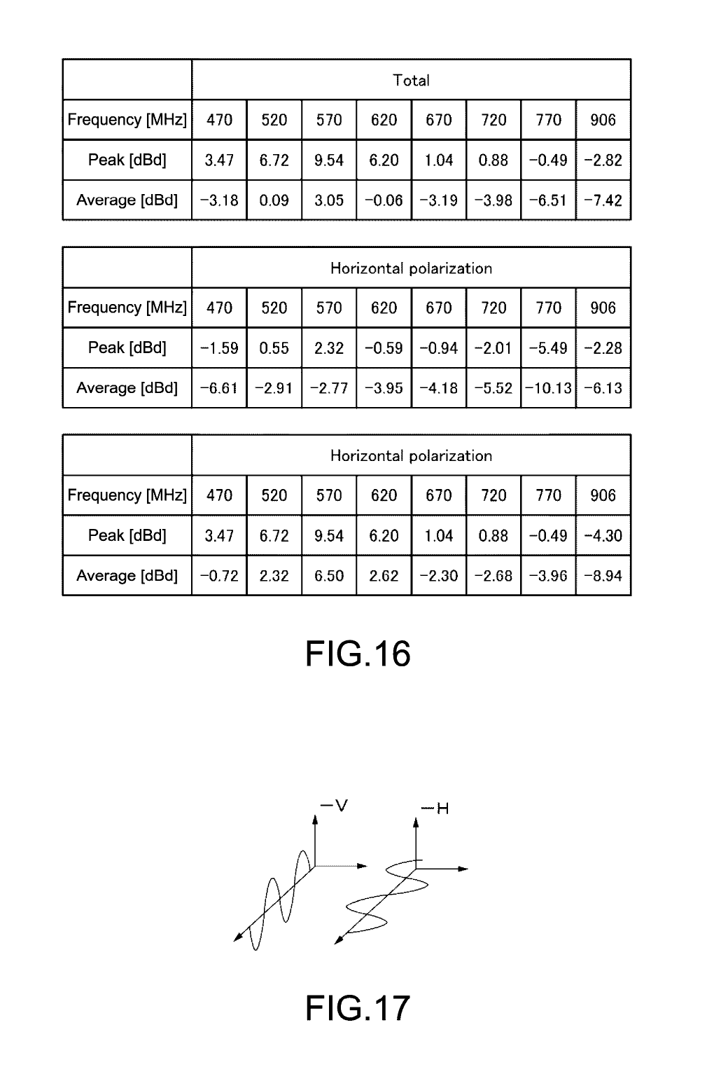

FIG. 15 shows measurement graphs regarding a directivity of the rod antenna element 103. FIG. 16 shows measurement data regarding the directivity of the rod antenna element 103. FIG. 16 shows measurement data in the horizontal polarization reception, measurement data in the vertical polarization reception, and total measurement data. It should be noted that the solid lines in the measurement graphs of FIGS. 13 and 15 indicate the directivities in the horizontal polarization reception, and the dotted lines indicate the directivities in the vertical polarization reception.

The measurement of the directivity was performed every 50 MHz within the range of 470 MHz to 770 MHz. Moreover, the directivity at 906 MHz was measured. The measurement of the directivity involves fixing, when measuring a radiation gain, a test antenna device (antenna apparatus 10) to a rotary table and measuring reception power while causing the table and the antenna device to rotate from 0 degree to 360 degrees within a horizontal plane, to measure a gain distribution in the horizontal plane. The measurement results shown in the figure are each expressed by a relative gain (unit: dBd) obtained by comparing the antenna gain with that of a half wavelength dipole antenna (maximum gain of 2.15 dBi).

FIG. 17 schematically shows two orthogonal cross polarizations (vertical polarization and horizontal polarization).

From FIGS. 13 and 15, it was confirmed that the directivities of the wire antenna element 102 and the rod antenna element 103 differ and that the elements compensate for the differences. Specifically, it was confirmed that a null point of the wire antenna element 102 is compensated by the rod antenna element 103, and a null point of the rod antenna element 103 is compensated by the wire antenna element 102. As a result, null points of the entire antenna apparatus 10 can be reduced, and a diversity function can be realized.

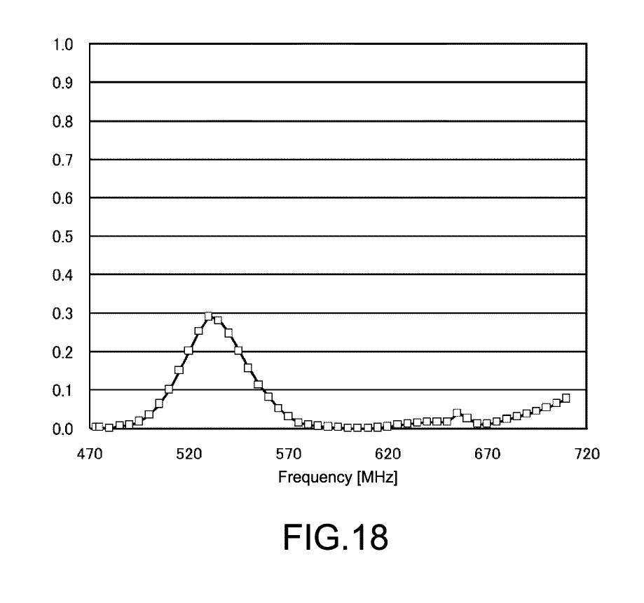

FIG. 18 shows an example of correlation coefficients of the wire antenna element 102 and the rod antenna element 103. It was confirmed that the correlation coefficients are lower than a setting value. For example, it was confirmed that the correlation coefficients become 0.3 or less.

As described above, according to the embodiment of the present disclosure, an antenna apparatus that has a favorable reception sensitivity and is resistant to noises can be provided. Further, an antenna apparatus that can be set easily can be provided. Furthermore, since the antenna apparatus can be made compact by removing the antenna elements, the antenna apparatus can be packed in a small box or the like with ease.

### 2. Modified Example

Heretofore, the embodiment of the present disclosure has been specifically described. However, the present disclosure is not limited to the embodiment described above and can be variously modified based on the technical idea of the present disclosure.

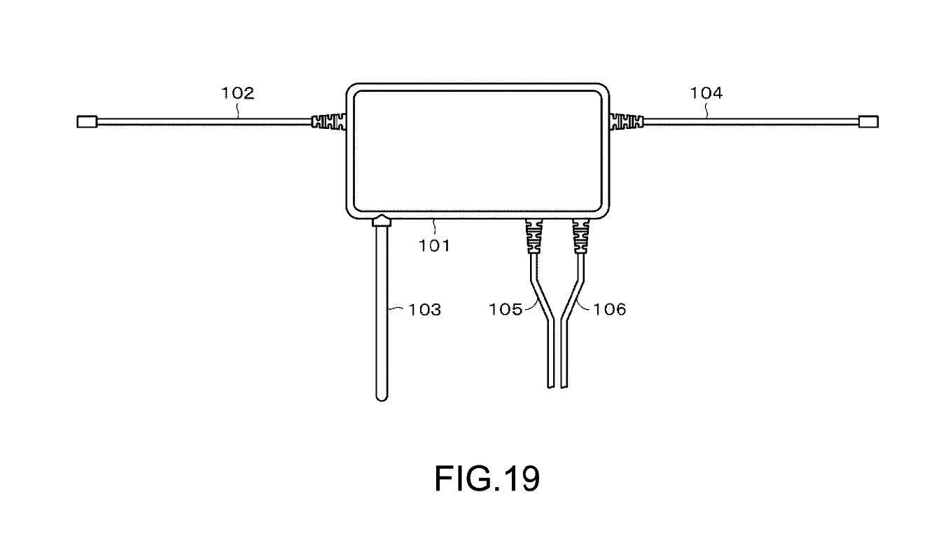

In the embodiment above, the draw-out direction of the coaxial cables is the front glass side. However, as shown in FIG. 19, the rod antenna element and the coaxial cables may be connected to the same side surface of the case. The coaxial cables may be drawn out to a driver side, for example. As described above, the connection positions of the antenna elements, the ground element, and the coaxial cables with respect to the case can be changed as appropriate.

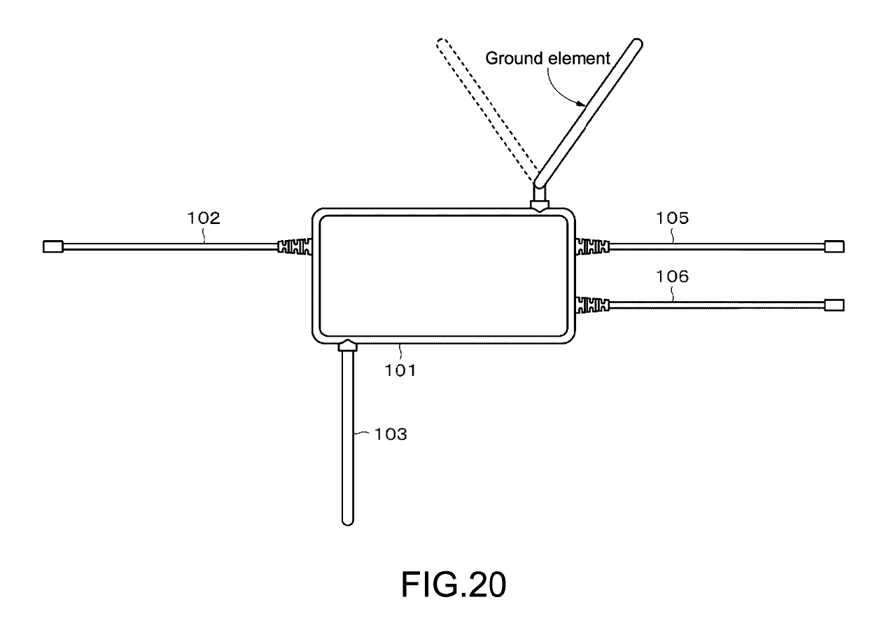

The ground element of the embodiment described above may be structured by a rod antenna element, and the ground antenna element may be structured to be detachable from the case. The number of groove sections to be formed in the jack of the case is not limited to two. For example, two groove sections may be formed on each of the straight intersecting lines, that is, a total of 4 groove sections may be formed. By switching the combination of the groove sections into which the protrusion is to be inserted as shown in FIG. 20, the position of the ground element can be adjusted. As a result, it becomes possible to switch the attachment angle of the ground element based on the angle of the pillars of the vehicle, for example. Also, a plurality of ground elements may be connected to the case.

The antenna element 102 of the embodiment described above may be structured by a rod antenna element, and the antenna element 102 may be structured to be detachable from the case. In other words, at least one of the antenna element 102 and the antenna element 103 only needs to be detachable from the case. Further, more antenna elements may be connected to the case. The cable that outputs reception signals received by the antenna apparatus is not limited to the coaxial cable, and a differential line may be used instead.

It should be noted that the structures and processing of the embodiment and modified example can be combined as appropriate unless a technical contradiction is not caused. The order of processing in the exemplified flow of processing can be changed as appropriate unless a technical contradiction is not caused. The numerical values, materials, measurement methods, and the like of the embodiment are mere examples and can be changed as appropriate.

The present disclosure may also take the following structures.

(1) An antenna apparatus, including:

a first antenna element and a second antenna element that receive at least one of broadcast waves and signals transmitted while being superimposed on the broadcast waves; and

a ground element that functions as a common ground of the first antenna element and the second antenna element,

at least one of the first antenna element and the second antenna element having an adjustable attachment angle.

(2) The antenna apparatus according to (1),

in which the second antenna element is, in a state where the first antenna element is set on a predetermined surface, positioned in a height direction with respect to the predetermined surface.

(3) The antenna apparatus according to (2),

in which the predetermined surface is a dashboard of a vehicle.

(4) The antenna apparatus according to any one of (1) to (3),

in which the ground element is capacitively coupled with a metal portion of a vehicle body in which the antenna apparatus is set.

(5) The antenna apparatus according to any one of (1) to (4), further including

a power feed section to which the first antenna element, the second antenna element, and the ground element are connected and that extracts signals received by the first antenna element and the second antenna element.

(6) The antenna apparatus according to (5),

in which the power feed section is accommodated in a predetermined case, and

in which at least one of the first antenna element and the second antenna element is detachable from the case.

(7) The antenna apparatus according to (6),

in which at least one of the first antenna element and the second antenna element is attached to the case via a round connector.

(8) The antenna apparatus according to (6) or (7),

in which the antenna apparatus can be used while a main surface of the case is inverted.

(9) The antenna apparatus according to (8),

in which the main surface and a surface on the other side of the main surface have marks indicating a setting direction of the antenna apparatus.

(10) The antenna apparatus according to any one of (1) to (9),

in which a correlation coefficient of the first antenna element and the second antenna element is smaller than a setting value when the first antenna element and the second antenna element are in a predetermined setting state.

(11) The antenna apparatus according to any one of (5) to (10),

in which a first amplifier connected to the first antenna element and a second amplifier connected to the second antenna element are formed on the power feed section.

(12) The antenna apparatus according to any one of (5) to (11),

in which a cable for transmitting the signals is connected to the power feed section, and

in which the cable includes a ferrite material.

(13) The antenna apparatus according to (12),

in which the cable is structured as a coaxial cable, and the ferrite material covers an outer side of mesh wires.

(14) The antenna apparatus according to (13),

in which a metal foil tape is used for the cable.

(15) The antenna apparatus according to any one of (5) to (11),

in which a cable for transmitting the signals is connected to the power feed section, and

in which the cable is constituted of a differential line.

### DESCRIPTION OF REFERENCE NUMERALS

10 antenna apparatus
101 case
102 wire antenna element
103 rod antenna element
104 ground element
105 coaxial cable
106 coaxial cable
112 main surface
120 wiring substrate
125 LNA
126 LNA
130 antenna section
131 support section
153 braided wires
154 ferrite material
156 single-sided aluminum foil tape
162 dashboard

1. An antenna apparatus, comprising:
a first antenna element and a second antenna element that receive at least one of broadcast waves and signals transmitted while being superimposed on the broadcast waves; and
a ground element that functions as a common ground of the first antenna element and the second antenna element,
at least one of the first antenna element and the second antenna element having an adjustable attachment angle.

2. The antenna apparatus according to claim 1,
wherein the second antenna element is, in a state where the first antenna element is set on a predetermined surface, positioned in a height direction with respect to the predetermined surface.

3. The antenna apparatus according to claim 2,
wherein the predetermined surface is a dashboard of a vehicle.

4. The antenna apparatus according to claim 1,
wherein the ground element is capacitively coupled with a metal portion of a vehicle body in which the antenna apparatus is set.

5. The antenna apparatus according to claim 1, further comprising
a power feed section to which the first antenna element, the second antenna element, and the ground element are connected and that extracts signals received by the first antenna element and the second antenna element.

6. The antenna apparatus according to claim 5,
wherein the power feed section is accommodated in a predetermined case, and
wherein at least one of the first antenna element and the second antenna element is detachable from the case.

7. The antenna apparatus according to claim 6,
wherein at least one of the first antenna element and the second antenna element is attached to the case via a round connector.

8. The antenna apparatus according to claim 6,
wherein the antenna apparatus can be used while a main surface of the case is inverted.

9. The antenna apparatus according to claim 8,
wherein the main surface and a surface on the other side of the main surface have marks indicating a setting direction of the antenna apparatus.

10. The antenna apparatus according to claim 1,
wherein a correlation coefficient of the first antenna element and the second antenna element is smaller than a setting value when the first antenna element and the second antenna element are in a predetermined setting state.

11. The antenna apparatus according to claim 5,
wherein a first amplifier connected to the first antenna element and a second amplifier connected to the second antenna element are formed on the power feed section.

12. The antenna apparatus according to claim 5,
wherein a cable for transmitting the signals is connected to the power feed section, and
wherein the cable includes a ferrite material.

13. The antenna apparatus according to claim 12,
wherein the cable is structured as a coaxial cable, and the ferrite material covers an outer side of mesh wires.

14. The antenna apparatus according to claim 13,
wherein a metal foil tape is used for the cable.

15. The antenna apparatus according to claim 5,
wherein a cable for transmitting the signals is connected to the power feed section, and
wherein the cable is constituted of a differential line.
